(19) United States
(12) Patent Application Publication
(10) Pub. No.: US 2020/0096161 A1
(43) Pub. Date: Mar. 26, 2020

(54) Double-colour LED lamp bead

(71) Applicant: Jinsong Chen, Jing County (CN)

(72) Inventor: Jinsong Chen, Jing County (CN)

(21) Appl. No.: 16/217,059

(22) Filed: Dec. 12, 2018

(30) Foreign Application Priority Data
Sep. 20, 2018 (CN) 201821541166.4

(51) Int. Cl. F21K 9/238; H05B 33/08

(52) U.S. Cl. CPC F21K 9/238; F21Y 2115/10; H05B 33/0857

(57) ABSTRACT

The invention disclosures a double-colour LED lamp bead, comprising, a lamp bead mounting plate, a lamp bead, a first weld leg and a second weld leg, wherein the lamp bead, the first weld leg and the second weld leg are arranged on the lamp bead mounting plate, the first and the second weld leg are respectively arranged on both sides of the lamp bead, a first light-emitting unit and a second light-emitting unit are provided inside the lamp bead, and have different light-emitting colour, the first light-emitting unit, the second light-emitting unit, the first weld leg and the second weld leg are connected in series by a wire. The advantageous effects of the invention are as follows: one single lamp bead can emit two colours of light, which achieves the energy conservation and environmental protection by saving lamp beads materials and has stability of light-emitting and long service life.

### BACKGROUND OF THE INVENTION

### 1. Field of the Invention

The invention relates to a double-colour LED lamp bead.

### 2. Background Art

With the widespread use of LEDs, people have gradually gained a deeper understanding of the characteristics, advantages and disadvantages of LEDs, the prior LEDs mainly include: DIP LEDs, SMD LEDs and high-power type LEDs, and most of the prior arts are adopted multiple lamp beads to emit light while there is no single lamp bead that can emit two colours of light.

### SUMMARY OF THE INVENTION

The object of the disclosure is to solve the problem mentioned in the background art by providing a double-colour LED lamp bead.

In order to solve the technical problem mentioned above, the disclosure provides a technical scheme: a double-colour LED lamp bead, comprising, a lamp bead mounting plate, a lamp bead, a first weld leg and a second weld leg, wherein the lamp bead, the first weld leg and the second weld leg are arranged on the lamp bead mounting plate, the first weld leg and the second weld leg are respectively arranged on both sides of the lamp bead, a first light-emitting unit and a second light-emitting unit are provided inside of the lamp bead, the first light-emitting unit and the second light-emitting unit have different light-emitting colour, the first light-emitting unit, the second light-emitting unit, the first weld leg and the second weld leg are connected in series by a wire.

As a preferred scheme, both the first light-emitting unit and the second light-emitting unit are both SMD LEDs.

The advantageous effects of the invention are as follows: two light-emitting units that can emit different colours of light are provided inside the lamp bead, thereby one single lamp bead can emit two colours of light at the same time, which is an innovation in the field of double-colour lamp bead and also achieves the energy conservation and environmental protection by saving materials of lamp beads. The light-emitting units are adopted SMD LEDs which have stability of light-emitting and long service life, and combinations of different colours of LEDs can be selected according to individual needs.

### BRIEF DESCRIPTION OF THE DRAWINGS

FIG. 1 shows the structure diagram of the invention.

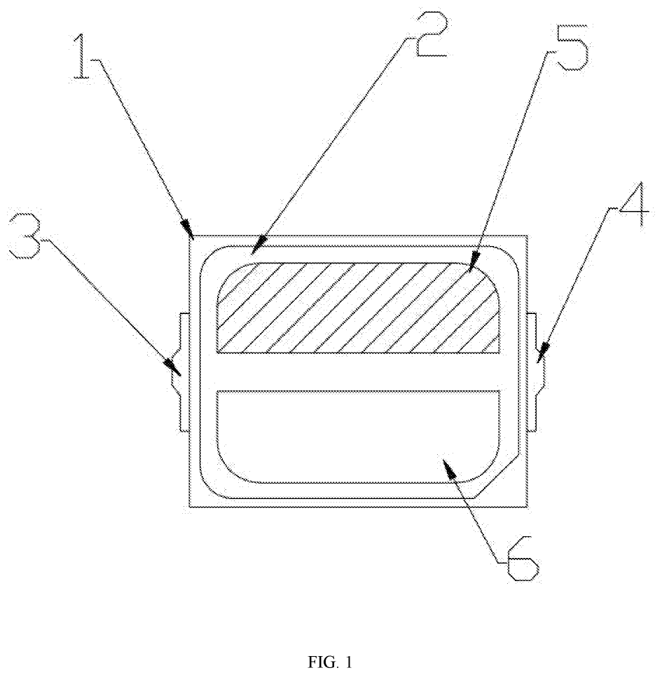

FIG. 2 shows the electrical diagram of the invention.

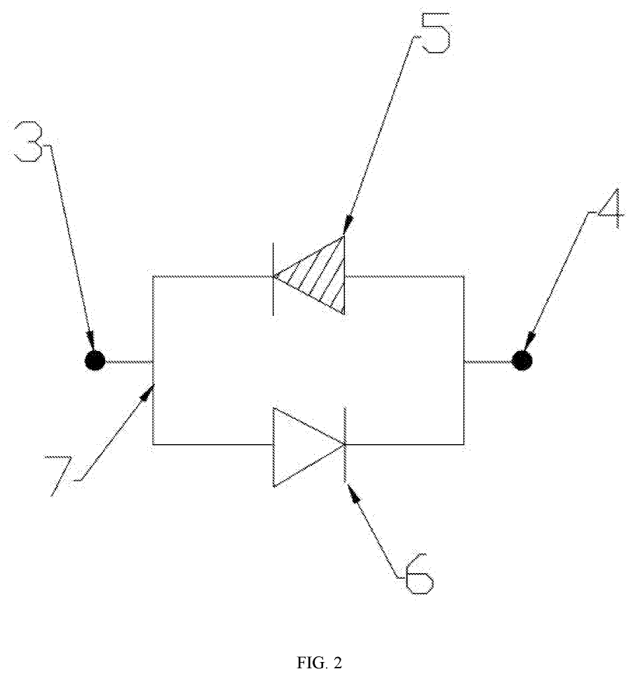

As shown in the drawings: 1 refers to the lamp bead mounting plate, 2 refers to the lamp bead, 3 refers to the first weld leg, 4 refers to the second weld leg, 5 refers to the first light-emitting unit, 6 refers to the second light-emitting unit, and 7 refers to the wire.

### DETAILED DESCRIPTION OF THE PREFERRED EMBODIMENTS

The invention will be further described in details below with reference to the accompanying drawings.

Combined with accompanying drawings, a double-colour LED lamp bead, comprising, a lamp bead mounting plate 1, a lamp bead 2, a first weld leg 3 and a second weld leg 4, wherein the lamp bead 2, the first weld leg 3 and the second weld leg 4 are arranged on the lamp bead mounting plate 1, the first weld leg 3 and the second weld leg 4 are respectively arranged on both sides of the lamp bead 2, a first light-emitting unit 5 and a second light-emitting unit 6 are provided inside of the lamp bead 2, the first light-emitting unit 5 and the second light-emitting unit 6 have different light-emitting colour, the first light-emitting unit 5, the second light-emitting unit 6, the first weld leg 3 and the second weld leg 4 are connected in series by a wire 7.

As a preferred embodiment, both the first light-emitting unit 5 and the second light-emitting unit 6 are both SMD LEDs.

The advantageous effects of the invention are as follows: two light-emitting units that can emit different colours of light are provided inside the lamp bead, thereby one single lamp bead can emit two colours of light at the same time, which is an innovation in the field of double-colour lamp bead and also achieves the energy conservation and environmental protection by saving materials of lamp beads. The light-emitting units are adopted SMD LEDs which have stability of light-emitting and long service life, and combinations of different colours of LEDs can be selected according to individual needs.

It should be paid attention to that the invention has to be protected from water, moisture and static electricity when packaging.

The invention and the embodiments thereof are described above and the descriptions are not restricted, what shown in the accompanying drawings is only one of the embodiments of the invention and the actual structure is not limited to the description. In conclusion, the similar structure and embodiments, which are uncreatively designed by those skilled in the art after being inspired by the invention and without departing from the purpose of creation of the invention, are included in the protection scope of the invention.

What is claimed is:

1. A double-colour LED lamp bead, comprising, a lamp bead mounting plate (1), a lamp bead (2), a first weld leg (3) and a second weld leg (4), wherein the lamp bead (2), the first weld leg (3) and the second weld leg (4) are arranged on the lamp bead mounting plate (1), the first weld leg (3) and the second weld leg (4) are respectively arranged on both side of the lamp bead (2), a first light-emitting unit (5) and a second light-emitting unit (6) are provided inside of the lamp bead (2), the first light-emitting unit (5) and the second light emitting unit (6) have different light-emitting colour, the first light-emitting unit (5), the second light-emitting unit (6), the first weld leg (3) and the second weld leg (4) are connected in series by a wire (7).

2. The double-colour LED lamp bead of claim 1, wherein, both the first light-emitting unit (5) and the second light-emitting unit (6) are SMD LEDs.
